(19) United States
(12) Patent Application Publication
(10) Pub. No.: US 2017/0140427 A1
(43) Pub. Date: May 18, 2017

(54) METHOD AND APPARATUS FOR RECOMMENDING PRODUCT FEATURES ON WHICH INADEQUATE TIME IS SPENT BY A USER

(71) Applicant: Adobe Systems Incorporated, San Jose, CA (US)

(72) Inventors: Tobias Bocanegra, San Francisco, CA (US); Sachin Soni, New Delhi (IN); Martin Buergi, Foster City, CA (US); Cedric Huesler, San Francisco, CA (US); Ashish Duggal, New Delhi (IN); Anmol Dhawan, Ghaziabad (IN)

(21) Appl. No.: 14/945,103

(22) Filed: Nov. 18, 2015

(51) Int. Cl. G06Q 30/02

(52) U.S. Cl. CPC G06Q 30/0255

(57) ABSTRACT

A method for recommending at least one feature of a product to a user is provided. The method includes tracking time spent on one or more features of the product during access of the product by the user. At least one feature on which time spent by the user is less than a predefined threshold is then identified. Entry of an electronic device of the user in a proximity region of an electronic screen is detected. Further, the at least one feature is recommended via the electronic screen. Apparatus for substantially performing the method as described herein is also provided.

### BACKGROUND

Often, a purchase cycle of a product includes trial of the product by a user. For conducting the trial, the user accesses the product online or via a brick and mortar store, and tries the product. During trial it may happen that the user tries some features of the product and misses out on some features that the marketer wants the user to try. In addition, it may also happen that the user spends less time on the feature that the marketer thinks is of higher importance and as such, requires more time. Hence, it is desired by the marketer to recommend the features on which the user spent inadequate time, i.e. the features missed by the user or the features on which the user spent less time, to the user.

In one existing technique, billboards or various other electronic screens are used to advertise or recommend products to the user. These electronic screens are, typically, placed in and around the brick and mortar store. However, the advertisements or recommendations that are displayed on the electronic screens are mainly static, i.e. are predefined by the marketer.

In another existing technique, dynamic advertising or recommending is performed on the electronic screens in order to better tailor the content for a targeted user. For example, an emotion tracking device is placed within the electronic screen. The emotion tracking device reads emotions of the user in front of it and then the recommendations or advertisements are played on the electronic screen accordingly. Various other ways of advertising or recommending, such as location based and weather based are in place but they still lack degree of targeting that a marketer desires, i.e. identifying features of a product on which the user spent inadequate time and recommending content or advertisement based on such identification.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method for recommending at least one feature of a product to a user is provided.

In one embodiment, the method includes tracking time spent on one or more features of the product during access of the product by the user. At least one feature on which time spent by the user is less than a predefined threshold is then identified. Entry of an electronic device of the user in a proximity region of an electronic screen is detected. Further, the at least one feature is recommended via the electronic screen.

In another embodiment, the method includes detecting entry of an electronic device of the user in a proximity region of an electronic screen. Data associated with the user is then retrieved from a storage device. Using the data, time spent on one or more features of the product during access of the product by the user is obtained. At least one feature on which time spent by the user is less than a predefined threshold is then identified. Further, the at least one feature is recommended via the electronic screen.

Apparatus for substantially performing the embodiments as described herein are also provided.

### BRIEF DESCRIPTION OF THE DRAWINGS

FIG. 1 is a diagram of an environment for recommending at least one feature on which inadequate time is spent by a user, according to one or more embodiments;

FIG. 2 is a flowchart of a method for recommending at least one feature on which inadequate time is spent by a user, according to one or more embodiments; and

FIG. 3 is a block diagram of an apparatus for recommending at least one feature on which inadequate time is spent by a user, according to one or more embodiments.

While the method and apparatus is described herein by way of example for several embodiments and illustrative drawings, those skilled in the art will recognize that the method and apparatus provided herein is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to. Moreover, although the terms “step” and/or “block” are used herein to connote different elements of methods employed, the terms should not be interpreted as implying any particular order among or between various steps herein disclosed unless and except when the order of individual steps is explicitly described.

### DETAILED DESCRIPTION OF EMBODIMENTS

### Overview

In accordance to embodiments of the present invention and as described in more detail below, a method for recommending at least one feature, of a product, on which a user spent inadequate time is provided. A user having an electronic device (hereinafter referred to as the user device 110) accesses a product 104. The product 104 can be a hardware product or a software product. The product 104 can be accessed by the user online, or by visiting a brick and mortar or a physical store (hereinafter referred to as the store 102). Time spent on one or more features of the product 104 during access of the product 104 by the user is tracked and is provided to a content management server 132, such as Adobe® Experience Manager. The tracking can be performed using various techniques and is described later using various embodiments. The time spent on a feature of the product 104 is then checked against a predefined threshold. The predefined threshold can be defined by a marketer of the product 104 or can be a default assigned value. If the time spent is less than the predefined threshold then the feature is identified as the feature on which inadequate time is spent by the user. Further, if the access of the product 104 is determined but there is no time spent on the feature by the user then also the feature is identified as the feature on which inadequate time is spent by the user. At least one feature on which inadequate time is spent by the user is identified from the one or more features of the product 104. One or more information, such as whether the user accessed the product 104, time spent on the one or more features, or identified at least one feature, is stored in a storage device 124. After access of the product 104, it may happen that the user enters a proximity region of an electronic screen 112, such as a billboard or a television screen or any display screen, present in the store 102. The electronic screen 112 is powered by, for example the content management server 132, and has an associated beacon 114. The entry of the user device 110 is detected in the proximity region of the electronic screen 112. The user device 110 has at least one application, such as an application 144, which is capable of receiving signals, such as screen beacon signals 120. The screen beacon signals 120 are then transmitted to a server, such as the content management server 132, directly or via one or more of intermediate servers, such as a retailer server 122 or a beacon-supporting application server 128. The user is identified using device data 118 and stored data for the user is retrieved from the storage device 124 by the content management server 132. A check is performed to determine if the user has accessed the product 104. If the user has accessed the product 104 then the at least one feature on which inadequate time is spent by the user is identified and recommended to the user via the electronic screen 112, such as by displaying. Hence, a more targeted recommendation to the user is provided. The recommendation is in sync with what the marketer desires and increases probability of a purchase of the product 104 by the user.

In one embodiment, the product 104 is present in the store 102 and is accessed by the user in the store 102. The user walks into the store 102 with the user device 110, such as a smartphone. The user then accesses the product 104. The product 104 has one or more beacons, such as a beacon 106, associated with the product 104. Product beacon signals 116 (beacon data) transmitted by the beacons of the product 104 are captured by the application 144 on the user device 110 and transmitted to the content management server 132, directly or via one or more of the intermediate servers. The product beacon signals 116 are processed, by the content management server 132 or one or more of the intermediate servers or a combination, to determine details of the product 104. The details of the product 104 includes one or more of name or identifier of the product 104, a location of the store 102, name of a company offering the product 104, a location of the product 104 in the store 102, and distance of the user device 110 from the product 104. A company of the content management server 132 partners with companies providing services of the intermediate servers to enable routing and processing of the product beacon signals 116. As described herein, the company of the content management server 132 is the company that provides functionality of the content management server 132. The intermediate servers can process the product beacon signals 116 to determine some details of the product 104 and remaining details can be determined by the content management server 132. In addition, the user device 110 also transmits information, such as the device data 118, which includes at least one of cookie based identifier, HTTP based identifier, IP address, user agent, device identifier or user identifier to the content management server 132. Using this information an identity of the user or the user device 110 or both is established by the content management server 132 or any other intermediate server. The information associated with the user or the user device 110 can be sent along with the product beacon signals 116 or separately. For example, the application 144 can include a piece of code to fetch the user identifier, such as email ID, or device identifier from one or more applications running on the user device 110, or from the application programming interfaces provided by operating system or the one or more applications running on the user device.

In one example of the illustrated embodiment, the product 104 includes a product, for example a car, which has various components having respective beacons. A beacon associated with a component, such as a steering of the car, is accelerometer-enabled, i.e. the beacon has a built-in accelerometer. The product beacon signals 116 received by the content management server 132 also includes information tracked by the accelerometer. The product beacon signals 116 are processed to determine movement of the component of the product 104. If a movement is detected then it is determined that the product 104 is accessed and hence, a trial of the product 104 is performed by the user. Time during which the user is in proximity to the product 104 and the component is under movement is tracked. Similar tracking is performed for various components of the product 104. If the time during which the component is moved while the user device 110 is in proximity to the product 104 is less than the predefined threshold then the component is identified as a feature on which inadequate time is spent by the user. If a movement of the component is not determined during the access of the product 104 then also the component is identified as a feature on which inadequate time is spent by the user, i.e. the component on which no time is spent and hence, the component is missed by the user. Output, such as one or more of list of features on which inadequate time is spent, identifier of the user, name or identifier of the product 104, name of the company of the product 104, and time spent on the one or more features, of processing of the product beacon signals 116 is stored. The user in the store 102 then moves away from the product 104 and can access more products. Outputs for accesses made to one or more products are determined and stored. The user while exploring the store 102 comes in a proximity region of the electronic screen 112. The electronic screen 112 is present in a configurable distance from the product 104, i.e. either the same store or a distance which is configurable or specified by the marketer. The screen beacon signals 120 from the beacon 114 of the electronic screen 112 are received by the application 144 on the user device 110 and transmitted to the content management server 132. In one scenario, the content management server 132 detects presence of the user device 110 in the proximity region to the electronic screen 112, retrieves the stored output for the product last accessed by the user, and recommends the features, of the last accessed product, on which inadequate time is spent by the user to the user via the electronic screen 112. In another scenario, the user, in addition to being present in the proximity region of the electronic screen 112, also interacts with the electronic screen 112. The interaction includes interacting with content of the product 104 on the electronic screen 112. The content management server 132 determines interaction of the user with the electronic screen 112 and also that the user is interacting with the electronic screen 112 for exploring the product 104, and retrieves the output for the product 104. The content management server 132 already knows content displayed on the electronic screen 112 as the electronic screen 112 is powered by the content management server 132. In addition, based on the screen beacon signals and the device data 118, the content management server 132 knows who is interacting with the electronic screen 112. At least one feature, of the product 104, on which inadequate time is spent by the user is then recommended to the user via the electronic screen 112.

In another example of the illustrated embodiment, the product 104 includes a product, for example a smartphone, which has various software applications installed on the product 104. One beacon 106 is attached to the product 104. The user tries the software application on the product 104. Usage of the software application is tracked by an application provider, i.e. company providing the application, or by a service provider that provides tracking services. In one embodiment, the application provider can include tracking code in the software application to track usage of the software application. The tracking code tracks the software application usage and provides the usage data to a server managed by the application provider. In another embodiment, the application provider uses services offered by the service provider by embedding a piece of code in the software application. The code enables tracking of software application usage and makes usage data available to the content management server 132 directly or via an intermediate tracking server, such as Adobe® Analytics. The usage of the software application indicates access and trial of the product 104 by the user. Time during which the user is in proximity to the product 104 and the software application is being used is tracked. Similar tracking is performed for other software applications. If the time during which the software application is used while the user device 110 is in proximity to the product 104 is less than the predefined threshold then the software application is identified as a feature on which inadequate time is spent by the user. If the software application is not accessed but movement of the product 104 is detected then also the application is identified as a feature on which inadequate time is spent by the user, i.e. the feature on which no time is spent and hence, the feature is missed by the user. The movement of the product 104 is detected using an accelerometer attached to the product 104 or to the beacon 106 attached to the product 104. Output of tracking of the software application and processing of the product beacon signals 116 are then stored. The user in the store 102 then moves away from the product 104 and can access more products. Outputs for accesses made to one or more products are determined and stored. Whenever the entry of the user is detected in the proximity region of the electronic screen 112, the list of features on which inadequate time is spent by the user is then recommended via the electronic screen 112 as described earlier.

In yet another example of the illustrated embodiment, the product 104 includes a software application present on a machine kept in the store 102. One beacon 106 is attached to the machine and hence, the product 104. The user tries the software application on the machine. Usage of the software application is tracked by an application provider, i.e. company providing the software application, or by a service provider that provides tracking services. The software application provider uses services offered by the service provider by embedding a piece of tracking code in the software application. The tracking code enables tracking of software application usage and makes usage data available to the content management server 132 directly or via the intermediate tracking server. The usage of the software application indicates access and trial of the software application, i.e. the product 104, by the user. Time during which the user is in proximity to the machine and the software application is being used is tracked. Similar tracking is performed for other software applications. If the time during which the software application is used while the user device 110 is in proximity to the software application is less than the predefined threshold then the software application is identified as a feature on which inadequate time is spent by the user. If the software application is not accessed but movement of the machine or component of the machine is detected using the accelerometer attached to the machine via the beacon 106 or directly, then also the software application is identified as a feature on which inadequate time is spent by the user, i.e. the feature on which no time is spent and hence, the feature is missed by the user. Output of tracking of the application and processing of the product beacon signals 116 are then stored. The user in the store 102 then moves away from the machine and can access more products. Outputs for accesses made to one or more products are determined and stored. Whenever the entry of the user is detected in the proximity region of the electronic screen 112, the list of features on which inadequate time is spent by the user is then recommended via the electronic screen 112 as described earlier.

In another embodiment, the product 104 is not necessarily accessed by the user in the store 102 but using any device, such as the user device 110, at any point of time. For example, the product 104 can be a software application accessed by the user using the user device 110 or any other device while the user is at home. Identity of the user and the user device 110 is determined using any existing technique or using techniques as described herein, such as using at least one of cookie based identifier, HTTP based identifier, IP address, user agent, device identifier or user identifier. The usage of the software application is tracked as described earlier. A feature level tracking of the software application is also performed using the tracking code. Time spent on one or more features of the product 104 is tracked and processed to identify at least one feature on which inadequate time is spent by the user. The processing can be performed by the content management server 132 or any of the intermediate servers, such as a product server or the intermediate tracking server. The product server includes a server that is managed by the company of the product 104. The output of the processing is then stored and recommended to the user when presence of the user device 110 is detected in proximity to the electronic screen 112. In one example, the product 104 and the electronic screen 112 are present in the store 102.

In some embodiments, over a period of time, a list of features, of the product 104, on which inadequate time is spent is stored for different users. The list of the features on which inadequate time is spent by at least a minimum number of users or the list of features that are recommended to more than a threshold number of users is generated. The list is provided to the marketer. The marketer then configures the services offered by the content management server 132 to recommend the generated list of features to a new user when the user device 110 of the new user is detected in the proximity region of the electronic screen 112 and no access of the product 104 by the new user is determined. The generated list of features can also be recommended by default using the electronic screen 112.

In some embodiments, the entry of the user device 110 in the proximity region of the electronic screen 112 is first detected. Data for the user is then retrieved from the storage device 124. Using the data, time spent on one or more features of the product 104 during access of the product 104 by the user is obtained. At least one feature on which time spent by the user is less than the predefined threshold is then identified. The at least one feature is then recommended to the user via the electronic screen 112.

### Terms Descriptions (in Addition to Plain and Dictionary Meaning of the Terms)

The beacon 106, for example an iBeacon™, is a device that broadcasts its identity to other electronic devices in form of signals, for example the product beacon signals 116. The broadcast or transmission is enabled using various technologies, such as Bluetooth®. The transmission includes one or more identifiers, such as universally unique identifier (UUID). The identifier is used to determine one or more of identity of the product 104, location of the store 102, location of the product 104 in the store 102, name of the store 102, identity of the company of the product 104, and distance of the user device 110 from the beacon 106. In one embodiment, the transmission includes the UUID of 16 byte string format that distinguishes a company's beacon from others. The UUID includes a major value which is a 2 byte string and is used to specify a beacon within a group. For example, if a retailer deploys 20 beacons in a store in San Francisco then all of the beacons will have same major value. The major value helps in identifying the location of the store 102 and hence, determining the store 102 in which a user is present. The UUID also includes a minor value which is a 2 byte string and is used to identify the location of the product 104 in the store 102. Various beacons are attached to various products and the products are kept at different locations in the store 102. The minor value helps determining the location, i.e. whether the product 104 is kept in mobile section of the store 102 or at store front or at any other location within the store 102. The UUID also includes a proximity value which is used to indicate distance of the user device 110 from the product 104 or the beacon 106. The distance can be categorized into various distinct ranges such as exemplary categories—Immediate or Close, Near, and Far. The beacon 106 can be in form of a sticker or a device. The beacon can also include one or more sensors or additional devices such as accelerometer and temperature sensor to track additional details. It will be apparent that any other technology capable of transmitting desired information or signals can be used and the beacon 106 is an example illustrated herein.

The beacon 114, for example an iBeacon™, is a device that broadcasts its identity to other electronic devices in form of signals, for example the screen beacon signals 120. The broadcast or transmission is enabled using various technologies, such as Bluetooth®. The transmission includes one or more identifiers, such as universally unique identifier (UUID). The identifier is used to determine one or more of the location of the store 102, the location of the electronic screen 112, the name of the store 102, and the distance of the user device 110 from the beacon 114. The distance can be categorized into various distinct ranges as described earlier. The beacon 114 can be similar to the beacon 106 but can be configured to transmit different set of information than the beacon 106.

A product, such as the product 104 is a software application or a hardware device accessed by the user. In one embodiment, the product 104 is present in the store 102 and includes the hardware device kept in the store 102 or a software application installed or present on a machine kept in the store 102. In another embodiment, the product 104 need not be present in the store 102 and includes a software application present on any device, such as the user device 110, accessible by the user. In various embodiments, the product 104 or the machine including the product 104 is associated or attached with one or more beacons, such as the beacon 106. The product 104 can include one or more components and different components can have respective beacons associated or attached with them.

A feature of the product 104 includes components of the product 104 or software applications present on the product 104 or any other functional or physical feature of the product 104. The feature can also include feature of the software application or any other material associated or attached to any component of the product 104. For example, if the product 104 is a car then the components can include steering, audio system, navigation system and the like. If the product 104 is a smartphone then the feature can include Health application installed on the smartphone or can include a scroll feature provided by operating system of the smartphone. If the product is a Health application then features can include any user interface button, or any offering or feature of the Health application.

A feature on which inadequate time is spent by a user includes features on which time spent by the user is less than a predefined threshold. The threshold can be specified by the marketer of the product 104, for example by using a user interface of the service offered by the content management server 132. The threshold can be different for different features or components of the product 104. The feature on which inadequate time is spent by the user includes the feature on which no time is spent by the user, i.e. the feature that is missed by the user.

A marketer is an entity or a person who markets products or features of the product 104 to a user. The marketer desires to market those features that can result in higher purchase of the product 104. The marketer uses services enabled by various embodiments described herein to recommend features that are inadequately tried by the user in the store 102 to the user.

A user is an entity or a person who accesses the product 104. In one embodiment, the user visits the store 102 to try one or more products. In another embodiment, the user need not visit the store 102 and accesses the product 104 via any device, such as the user device 110. The user carries the user device 110 that is capable of receiving signals broadcasted by the beacon 106 and the beacon 114, and transmitting the signals for further processing.

An electronic device, such as the user device 110, is a mobile or portable device carried by the user. The user device 110 includes any mobile phone or smart phone or similar device with processing capability, memory, and communications facility. The user device 110 is capable of receiving signals broadcasted by the beacon 106 and the beacon 114, and transmitting the signals for further processing.

An electronic screen, such as the electronic screen 112, is a device including a display and is in electronic communication with other devices or server to receive recommendations for display to the user. In one embodiment, the electronic screen is in communication with the content management server 132. The electronic screen 112 can be present in the store 102 or at any other configurable distance from the product 104.

The content management server 132 is a server used for facilitating recommendation of at least one feature, of the product 104, on which inadequate time is spent by the user during access of the product 104 by the user. The content management server 132 can include various servers for processing signals or data, and in some embodiments can also include or be connected to an analytics server (the intermedia tracking server) for tracking time spent on one or more features of the product 104. Example of the content management server 132 includes a server powered by Adobe® Experience Manager and an example of the analytics server includes a server powered by Adobe® Analytics.

A beacon-supporting application server 128 is a server used for processing the beacon signals, such as the product beacon signals 116. The beacon-supporting application server 128 processes the beacon signals to determine some details of the product 104. In one embodiment, the beacon-supporting application server 128 is managed by a company that provides the application 144 for purpose of receiving the beacon signals. The application 144 then transmits the product beacon signals 116 which are received by the beacon-supporting application server 146. The company of the content management server 132 partners with the company of the beacon-supporting application server 128 or with the retailer to obtain the product beacon signals 116 or output of processing of the product beacon signals 116 by the beacon-supporting application server 128 to the content management server 132. In another embodiment, the beacon-supporting application server 128 is managed by the retailer and is included in the retailer server 122. In yet another embodiment, the beacon-supporting application server 128 is managed by the company of the content management server 132 and is included in the content management server 132. It would be apparent to one of ordinary skill in the art that in one or more embodiments the beacon-supporting application server 128 could be operated by any entity capable of making the signals or data accessible to the content management server 132.

In the following discussion, an “Example Environment” is first described that is operable to employ methods described herein. Following this, a section entitled “Example Method” describes an example method in accordance with one or more embodiments.

### Example Environment

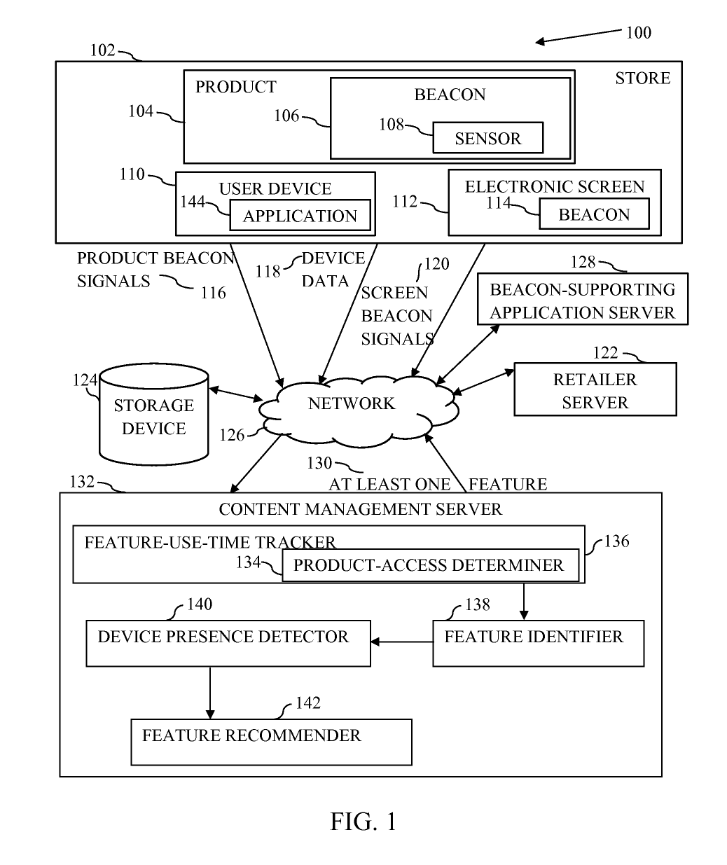

FIG. 1 is a diagram of an environment 100 for recommending at least one feature, of a product, on which inadequate time is spent by a user, according to one or more embodiments.

### Functional Description of Environment

The functional working of the environment 100 is now explained.

The environment 100 includes the store 102. The store includes one or more products. In illustrated example, the store 102 is powered by beacons and as such, the product 104 of the store 102, typically, has one or more beacons attached to it. A company (retailer) owning the store 102 can avail the beacons from a beacon provider, i.e. an organization providing beacons and related infrastructure. Beacons are placed at appropriate locations in the store 102 and are associated with one or more products. The beacons are configured by retailer to enable the beacons to transmit relevant information including their location. A table indicating mapping of the beacons with corresponding configuration data is maintained by the retailer and is stored in the retailer server 122. The retailer server 122 is accessible via a network 126.

In one embodiment, the product 104 has the beacon 106 attached or associated with it. In another embodiment, the product 104 has multiple beacons (not all beacons are shown in FIG. 1) attached to it. The product 104 can include multiple components and as such, can have one beacon 106 for each component. The beacon 106 broadcasts the product beacon signals 116 that include various information related to the product 104. In illustrated embodiment, the beacon 106 also includes a sensor 108. The sensor senses variables that it is configured to sense. In one example, the sensor 108 is an accelerometer which is configured to sense movement of the product 104.

The store also includes the electronic screen 112 which is within a configurable distance of the product 104. The electronic screen 112 also has the beacon 114 attached or associated to it. The electronic screen 112 and the user device 110 are also connected to a network 126 for transmitting or receiving information.

In one embodiment, the product 104 is present in the store 102. A user using the user device 110 visits the store 102 and accesses the product 104. The user device 110 has the application 144 that receives the product beacon signals 116 or the screen beacon signals 120 broadcasted by beacons, such as the beacon 106 or the beacon 114. The application 146 also transmits the beacon signals or data represented by the beacon signals to one or more servers, such as the content management server 132, the retailer server 122, or the beacon-supporting applications server 128. The beacon signals or the data represented by the beacon signals can be transmitted to the content management server 132 directly or can be sent to the content management server 132 via the retailer server 122 or via the beacon-supporting application server 128. The application 144 can be provided by the retailer or can be provided by affiliate or partner applications or can be provided by a company offering the product 104. The beacon-supporting application server 128 belongs to the company offering the application 144.

It would be apparent to one of ordinary skill in the art that in one or more embodiments the different servers could be operated by different entities or the same entities. For example, if the application 144 is provided by the affiliate or partner then all three servers, i.e. the content management server 132, the retailer server 122 and the beacon-supporting application server 128 exist separately and are owned by different entities while if the application 144 is provided by the retailer then the retailer server 122 and the beacon-supporting application server 128 can be just one server or can be owned by the retailer. In various embodiments, the server collecting the data or the beacon signals provides the data or the beacon signals to the content management server 132.

In one example, the user visits the store 102 and starts exploring the product 104. When the user device 110 comes in proximity to the beacon 106, the application 144 on the user device 110 starts receiving the product beacon signals 116 broadcasted by the beacon 106. The application transmits the product beacon signals 116, to the content management server 132 via the network 126. In one embodiment, the product beacon signals 116 are transmitted to the content management server 132 without processing by the intermediate servers and the processing is performed by the content management server 132 to determine details of the product 104. In another embodiment, the product beacon signals 116 are processed by intermediate servers to determine details of the product 104 and the details are then provided to the content management server 132 for further processing. The product beacon signals 116 includes one or more of information of the product 104, the location of the store 102, the name of the company offering the product 104, the location of the product 104 in the store 102, and the distance of the user device 110 from the product 104. The product beacon signals 116 include one or more identifiers, such as universally unique identifier (UUID), and have been described earlier, in detail, in conjunction with the beacon 106. The UUID also includes a proximity value which is used to indicate distance of the user device 110 from the product 104 or the beacon 106. The distance can be categorized into various distinct ranges such as exemplary categories—Intermediate or Close (within 0.5 meters), Near (within three meters but greater than 0.5), and Far (greater than three meters. In one embodiment, the distance is determined using following formula.

D=Di*ê[(RSSI−Ai)/10n], where

RSSI (received signal strength indicator)=Measured signal level by the user device 110 in dBm,

D=distance in meters,

n=Path loss exponent,

Di=reference distance, and

Ai=calibrated RSSI at Di in dBm.

In illustrated embodiment, Di=1 meter and hence, D=ê[(RSSI−A)/10n]. “n” is a function of environment, i.e. transmission medium—indoor or outdoor, and is deduced using empirical data.

In addition to the product beacon signals 116, the content management server 132 also receives device data 118 from the user device 110. The device data 118 includes at least one of cookie based identifier, HTTP based identifier, IP address, user agent, device identifier or user identifier. Using the device data 118, an identity of the user or the user device 110 is established. Various existing technologies for obtaining the device data 118 can be used. In one embodiment, the device data 118 is provided to the content management server 132 using the application 144. The application 144 obtains the user identifier, such as email ID or any other identifier, or device identifier from other applications on the user device 110 and provides the identifiers to the content management server 132 or to one or more of the intermediate servers.

In some embodiments, the content management server 132 can also receive additional data from the retailer server 122, or the beacon-supporting application server 128. This additional data can include information related to the product 104, the store 102, the beacon 106, the mapping among any of these, or any other data that is tracked. For example, the additional data includes product name, name of a component of the product 104, the identifier of the beacon 106 attached to the component, name or description of a feature of the product 104, the identifier of the beacon 106 attached to the product 104 and the like.

The content management server 132 is a computing device including at least one processor and that is capable of performing various functions described herein. One or more content management server 132 may be utilized to carry out embodiments described herein. The content management server 132 include various sub-processing units, which can be part of one or more processors, to perform various functions.

The content management server 132 includes a product-access determiner 134 to determine access of the product 104 by the user. In one embodiment, the product-access determiner 134 determines access of the product 104 by identifying presence of the user device 110 in proximity to the product 104 and determining access of the product 104 when the user device 110 is in proximity to the product 104. The product-access determiner 134 identifies the presence of the user device 110 in proximity to the product 104 by processing the product beacon signals 116 and determining distance of the user device 110 from the beacon 106. The product 104 can be of different types and hence, the technique of determining access of the product 104 is based on type of the product 104. For example, if the product 104 is a hardware product including multiple components then each component is attached to a respective beacon. As described herein, the component can be any part, of the product 104, for which tracking is desired. The data from the respective beacon includes data from the sensor indicating movement of the component which indicates access of the product 104. If the product 104 includes a single product then movement of the product 104 indicates access of the product 104. If the product 104 includes a single product with multiple software applications then use of any software application present on the product 104 indicates access of the product 104. The use of the software application is determined using usage data collected by the application provider. The usage is tracked using various existing techniques, such as via JavaScript or cookies or any other tracking technique. Tracking code is embedded in the software application to track usage of the software application. The tracking code tracks the software application usage and makes the usage data available for the product-access determiner 134. Feature level tracking can also be performed. For performing feature level tracking, unique identifier, such as user interface button or tool, for each feature is used. In one embodiment, the usage data is tracked by the application provider and the product-access determiner 134 fetches the usage data from the server of the application provider. In another embodiment, the application provider uses services offered by a tracking service provider, such as Adobe® Analytics, and the product-access determiner 134 fetches the usage data from the intermediate tracking server powered by Adobe® Analytics.

In some embodiments, the product 104 is not necessarily accessed by the user in the store 102 but using any device, such as the user device 110, at any point of time. For example, the product 104 can be a software application accessed by the user using the user device 110 or any other device while the user is at home. Identity of the user and the user device 110 is determined using any existing technique or using techniques as described herein, such as using at least one of cookie based identifier, HTTP based identifier, IP address, user agent, device identifier or user identifier. The usage of the software application is tracked as described earlier. A feature level tracking of the software application is also performed using the tracking code.

The content management server 132 also includes a feature-use-time tracker 138 to track time spent on one or more features of the product 104. In some embodiments, the tracking is performed for each feature. The time spent is tracked or determined using the product beacon signals 116. An intersection of the time during which the user device 110 is in proximity to the product 104 and the time during which the component of the product 104 is in movement is determined as time spent on that component of the product 104. Similarly, an intersection of the time during which the user device 110 is in proximity to the product 104 and the time during which the software application on the product 104 is under usage is determined as time spent on that feature of the product 104. Further, an intersection of the time during which the user device 110 is in proximity to the machine including the software application (product 104) and the time during which the software application is under usage is determined as time spent on that feature of the software application. In some embodiments, the feature-use-time tracker 138 includes the product-access determiner 134 and performs the functionalities of the product-access determiner 134.

A feature identifier 140 then checks the time spent on one or more features against a predefined threshold. In some embodiments, the check is performed for each feature. The predefined threshold is configurable and the marketer of the product 104 can configure different threshold for different features of the product 104. The time spent on the feature is checked against respective predefined threshold. If the time spent is less than the respective predefined threshold then that component or software application or feature of the software application is identified as a feature on which time spent by the user is inadequate. If no time is spent on that component or on the software application or on the feature of the software application during the access of the product 104 then also the component or the software application or the feature of the software application is identified as the feature on which time spent by the user is inadequate, i.e. missed feature or no time spent. A list of the features, of the product 104, on which the user spent inadequate time is prepared and stored in a storage device 124 by the content management server 132. The list includes other details, such as one or more of the product identifier or name, the list of features, time spent on one or more features, the device identifier, and the user identifier. The list is prepared for various users and is tagged with unique user identifier. In some embodiments, two different categories can be created and tracked for features of the product 104. The two different categories include a first category including features on which time spent by the user is less than the predefined threshold but the feature is accessed and a second category including features missed by the user. In such embodiments, the categories are also stored in the storage device 124. The different categories can help a marketer provide more targeted message to the user.

The user continues to explore or try the product 104 or any other product in the store 102. The user moves around the store 102 and in illustrated embodiment, enters into a proximity region of the electronic screen 112. The application 144 on the user device 110 receives the screen beacon signals 120 transmitted by the beacon 114. The screen beacon signals 120 or the data represented by the screen beacon signals 120 are then sent to the content management server 132. The content management server 132 also receives the device data 118. A device presence detector 140 processes the screen beacon signals 120 and the device data 118 to detect entry of the user device 110 in the proximity region of the electronic screen 112. A feature recommender 142 then accesses the data corresponding to the user device 110 and the product 104 stored in the storage device 124, retrieves the data including the features on which inadequate time is spent by the user, and provides the features on which inadequate time is spent by the user to the electronic screen 112. The electronic screen 112 then displays the features to the user. In one embodiment, the feature recommender 142 retrieves at least one feature on which inadequate time is spent by the user for the product last accessed by the user, and recommends the at least one feature to the user via the electronic screen 112. In another embodiment, the user, in addition to being present in the proximity region of the electronic screen 112, also interacts with the electronic screen 112. The interaction includes interacting with content of the product 104 on the electronic screen 112. The content management server 132 determines interaction of the user with the electronic screen 112 and also that the user is interacting with the electronic screen 112 for exploring the product 104, and retrieves at least one feature on which inadequate time is spent by the user for the product 104. The at least one feature, of the product 104, on which inadequate time is spent by the user is then recommended to the user via the electronic screen 112.

In some embodiments, the proximity region of the electronic screen 112 and the proximity of the product 104 are defined as the region which results in signal indicative of Immediate category of the distance range, i.e. the user device 110 is less than 0.5 meters from the beacon 106 or the beacon 114.

Recommending features on which inadequate time was spent by the user helps the marketer in targeting the user with appropriate features. The user can then try such features which in turn increases likelihood of purchase of the product 104 by the user.

In various embodiments, over a period of time, over a period of time, a list of features, of the product 104, on which inadequate time is spent is stored for different users. The list of the features on which inadequate time is spent by at least a minimum number of users or the list of features that are recommended to more than a threshold number of users is generated. The list is provided to the marketer. The marketer then configures the services offered by the content management server 132 to recommend the generated list of features to a new user when the user device 110 of the new user is detected in the proximity region of the electronic screen 112 and no access of the product 104 by the new user is determined. The generated list of features can also be recommended by default using the electronic screen 112.

At any point, an output of any of the elements of the content management server 132 described above may be stored in appropriate storage medium. Also, the elements can perform their functionalities in real time, or can perform the functionalities offline and store the pre-computed values in appropriate storage medium. For example, in some embodiments, the entry of the user device 110 in the proximity region of the electronic screen 112 is first detected. Data for the user is then retrieved from the storage device 124. Using the data, time spent on one or more features of the product 104 during access of the product 104 by the user is obtained. At least one feature on which time spent by the user is less than the predefined threshold is then identified. The at least one feature is then recommended to the user via the electronic screen 112.

### Hardware Description of Environment

The environment 100 includes one or more user devices, such as the user device 110. The user device 110 communicates with the content management server 132, the retailer server 122, and the beacon-supporting application server 128 via the network 126. The environment 100 also includes the storage medium or device 124 accessible via the network 126, or directly by the content management server 132.

The content management server 132 can be present at one single location or can be present at different locations in a distributed environment. One or more content management servers 132 may be utilized to carry out embodiments described herein. Each content management server 132 is capable of accessing the Internet, such as the World Wide Web. The content management server 132 takes on a variety of forms, such as a personal computer (PC), a server, a desktop computer, a processing unit, any combination of these devices, or any other suitable device having one or more processors. Further, the content management server 132 includes one or more processors, and one or more computer-readable media. The computer-readable media may include computer-readable instructions executable by the one or more processors. As further described herein, the content management server 132 includes memory and processors to perform recommendation. The one or more processors further includes multiple elements to perform various portions of the method.

The content management server 132 includes a Central Processing Unit (CPU) 204, support circuits 206, and a memory 208. The CPU 204 includes one or more commercially available microprocessors or microcontrollers that facilitate data processing and storage. The various support circuits 206 facilitate the operation of the CPU 204 and include one or more clock circuits, power supplies, cache, input/output circuits, and the like. The memory 208 includes at least one of Read Only Memory (ROM), Random Access Memory (RAM), disk drive storage, optical storage, removable storage or the like. The memory 208 includes an operating system 210, and a processing engine 212. The operating system 208 includes various commercially known operating systems.

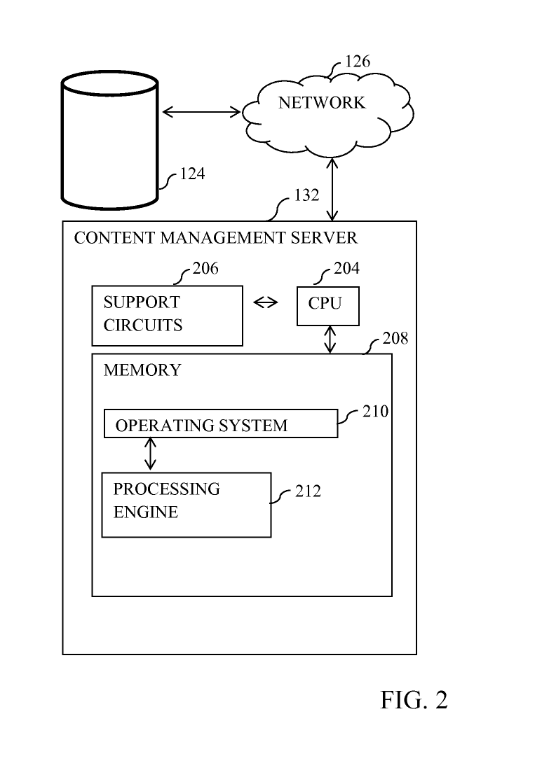

The content management server 132 may further include one or more input devices (not shown in FIG. 2) connected to the content management server 132. Examples of the one or more input devices include, but are not limited to, peripheral devices, keyboard, mouse etc. In some embodiments, the content management server 132 may not be connected to the input devices separately and may have functionalities of these input devices built into the content management server 132, such as in cases in which the content management server 132 is touch enabled device, gesture enabled device, or paired to such similar devices that act as the input devices. The processing engine 212 includes various other engines, such as the product-access determiner 134, the feature-use-time tracker 136, the feature identifier 138, the device presence detector 140 and the feature recommend 142, to perform methods as described herein.

The storage device 124 is, for example, a storage drive or a storage system, or a distributed or shared storage system. In some embodiments, the storage device 124 is coupled to a processing device (not shown) to facilitate extraction or retrieval or access of data stored in the storage device 124, or is directly accessible by the content management server 132.

Examples of the user device 110 include, but are not limited to, a desktop computer, a smartphone, a tablet computer, a laptop computer, a mobile computer or any other electronic device having one or more processors. Each user device includes a Central Processing Unit (CPU), support circuits, and a memory. The CPU may include one or more commercially available microprocessors or microcontrollers that facilitate data processing and storage. The various support circuits facilitate the operation of the CPU and include one or more clock circuits, power supplies, cache, input/output circuits, and the like. The memory may include at least one of Read Only Memory (ROM), Random Access Memory (RAM), disk drive storage, optical storage, removable storage or the like. The memory includes an operating system. The operating system includes various commercially known operating systems. The user device 110 may further include one or more input devices connected to the user device 110. Examples of the one or more input devices include, but are not limited to, peripheral devices, keyboard, mouse etc. In some embodiments, the user device 110 may not be connected to the input devices separately and may have functionalities of these input devices built into the user device 110, such as in cases in which the user device 110 is touch enabled device, gesture enabled device, or paired to such similar devices that act as the input devices.

Examples of the network 126 include, but are not limited to, internet, local area network (LAN), wireless area network, wired area network etc.

Examples of the retailer server 122 or the browser-supporting application server 128 include, but are not limited to, a personal computer (PC), a server, a desktop computer, a processing unit, any combination of these devices, or any other suitable device having one or more processors. Each server includes a Central Processing Unit (CPU), support circuits, and a memory. The CPU includes one or more commercially available microprocessors or microcontrollers that facilitate data processing and storage. The various support circuits facilitate the operation of the CPU and include one or more clock circuits, power supplies, cache, input/output circuits, and the like. The memory includes at least one of Read Only Memory (ROM), Random Access Memory (RAM), disk drive storage, optical storage, removable storage or the like. The memory includes an operating system. The operating system includes various commercially known operating systems. Each server may further include one or more input devices connected to the respective server. Examples of the one or more input devices include, but are not limited to, peripheral devices, keyboard, mouse etc. In some embodiments, each server may not be connected to the input devices separately and may have functionalities of these input devices built into the respective server, such as in cases in which the respective server is touch enabled device, gesture enabled device, or paired to such similar devices that act as the input devices.

Examples of the electronic screen 112 include, but are not limited to, a personal computer (PC), a desktop computer, a television, a light emitting diode (LED) television or screen, a billboard, a display unit, any combination of these devices, or any other suitable device having a display screen. The electronic screen 112 includes or is connected to a Central Processing Unit (CPU), support circuits, and a memory. The CPU includes one or more commercially available microprocessors or microcontrollers that facilitate data processing and storage. The various support circuits facilitate the operation of the CPU and include one or more clock circuits, power supplies, cache, input/output circuits, and the like. The memory includes at least one of Read Only Memory (ROM), Random Access Memory (RAM), disk drive storage, optical storage, removable storage or the like. The memory includes an operating system. The operating system includes various commercially known operating systems. The electronic screen 112 may further include one or more input devices connected to the respective server. Examples of the one or more input devices include, but are not limited to, peripheral devices, keyboard, mouse etc. In some embodiments, the electronic screen 112 may not be connected to the input devices separately and may have functionalities of these input devices built into the electronic screen 112, such as in cases in which the electronic screen is touch enabled device, gesture enabled device, or paired to such similar devices that act as the input devices.

The algorithms and method for performing various operations of the content management server 132 is now explained in conjunction with example method.

### Example Method

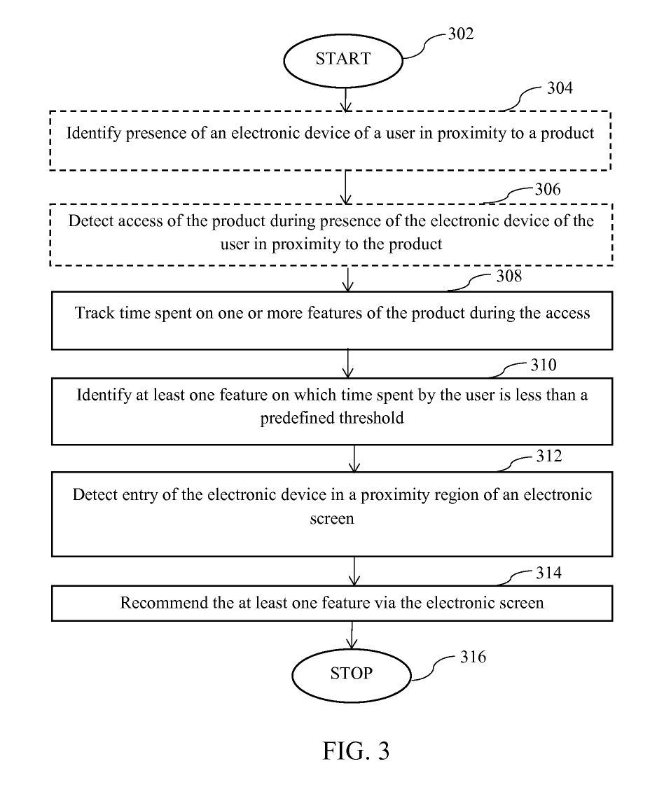

FIG. 3 is a flowchart of a method for recommending at least one feature on which inadequate time is spent by a user by a content management apparatus, for example the content management server 132, according to one or more embodiments.

The method starts at step 302 and proceeds to step 304.

At step 304, presence of an electronic device (user device) of a user is determined in proximity to a product. The product is present in a store. A beacon is attached to the product. In some embodiments, in which the product is a software application installed on a machine kept in the store, the beacon is attached to the machine and hence, the software application (product) is also associated with the beacon.

As a user approaches the product, an application present on the user device captures signals transmitted by the beacon. The signals are then either sent to the content management apparatus directly or the signals are routed to the content management apparatus via some other server, such as the retailer server 122 or the beacon-supporting application server 128. The routing is dependent on provider of the application. For example, if the application is provided by the retailer then the signals are collected by the retailer server 122 and then sent to the content management apparatus. Similarly, if the application is provided by an affiliate or partner then the signals are routed through the beacon-supporting application server 128. The signals include information such as the product beacon signals 116. In addition, other information such as the device data 118 is also provided to the content management apparatus. The signals are then processed to determine beacon identifier. The beacon identifier is processed to identify product name to which the beacon is attached and in case the beacon is attached to a component of the product then the component name is also identified. In one embodiment, the marketer using the services provided by the content management apparatus or the retailer, or the partner or the affiliate provides a table including product name and the beacon identifier as an input. In some embodiments, the input also includes component name or identifier or feature name or identifier. The table is stored and is accessible by the content management apparatus. Once beacon identifier from the signal is mapped to the beacon identifier provided by the marketer, remaining information is retrieved. A user device identifier received from the user device, using various existing techniques, is used to establish identity of the user device. The user device is determined to be in proximity of the product as long as signals from the beacon attached to the product are received. In one embodiment, the user device is determined to be in proximity when the signals received are Immediate, i.e. the user device is within 0.5 meters from the beacon. In other embodiments, other distance criteria for determining the user device to be in proximity to the beacon can be used.

At step 306, access of the product by the user during presence of the user device in proximity to the product is detected. In one embodiment, the access (trail) is detected for a product having multiple components by processing received signals to determine movement of a component of the product. In another embodiment, the access is detected for a product having multiple software applications present on the product by receiving additional usage statistics of the software application from the provider of the application and processing the usage statistics to determine usage of the application. In yet another embodiment, the access is detected for the software application by receiving usage statistics of the application present on the machine kept in the store while the user device is in proximity to the machine, i.e. the software application.

In some embodiments, step 304 and step 306 are part of step 308.

At step 308, time spent on one or more features of the product during access of the product by the user is tracked. Time spent is an intersection of time during which the user device is in proximity to the product and the time during which either movement of the component of the product or the product is detected, or the time during which the software application present on the machine or on the product is used.

In some embodiments, the product, such as a software application, may be accessed by the user from the home using any device. In such scenarios, the user device need not be in proximity to the product. The access and the usage, including the time spent, are tracked using the tracking code embedded in the software application.

At step 310, at least one feature on which time spent by the user is less than a predefined threshold is identified. The threshold may differ for different features or components and is configurable by the marketer. Time spent on a feature or component is checked against respective threshold and if no time is spent or time spent is less than the respective threshold during access of the product then the feature or the component is identified as the feature on which inadequate time is spent by the user. A list is prepared for various users and is stored with details such as one or more of user identifier, user device identifier, product name, name of features, and beacon identifier.

At step 312, entry of the user device in a proximity region of an electronic screen, such as the electronic screen 112, is detected. The user device captures the signals broadcasted by a beacon, such as the beacon 114, of the electronic screen. As soon as the user device enters the proximity region of the electronic screen, the signals from the beacon are detected by the application and sent to the content management apparatus. The device data is also sent to the content management apparatus by the application. The signals and the device data are then processed to extract beacon identifier and the user identifier or the user device identifier. Using the user identifier or the user device identifier a determination of the list of features on which inadequate time is spent by the user is retrieved. Using the beacon identifier the electronic screen is identified and the identified list of features is sent for display on the electronic screen. The identified feature is recommended to the user via the display on the electronic screen. Targeted recommending increases chances of purchase by the user and benefits the marketer.

In some embodiments, over a period of time, a list of features, of the product, on which inadequate time is spent is stored for different users. The list of the features on which inadequate time is spent by at least a minimum number of users or the list of features that are recommended to more than a threshold number of users is generated. The list is provided to the marketer. The marketer then configures the services offered by the content management apparatus to recommend the generated list of features to a new user when the user device of the new user is detected in the proximity region of the electronic screen and no access of the product by the new user is determined. The generated list of features can also be recommended by default using the electronic screen.

In some embodiments, the order of steps as described in FIG. 3 varies. For example, step 312 can be performed first followed by step 304 to step 310, and step 314. Other variations are also possible and are covered within scope of this description.

The embodiments of the present invention may be embodied as methods, apparatus, electronic devices, and/or non-transient or non-transitory computer program products or computer readable medium. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable medium having computer-usable or computer-readable program code embodied in the non-transient or non-transitory medium for use by or in connection with an instruction execution apparatus. In the context of this document, a computer-usable or computer-readable medium may be any medium that can contain, store, communicate, propagate, or transport the program for use by or in connection with the instruction execution apparatus, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

Examples of the computer-usable or computer-readable medium include, but are not limited to, an electronic, magnetic, optical, electromagnetic, infrared, or semiconductor apparatus, apparatus, device, or propagation medium. More specific examples (a non-exhaustive list) of the computer-readable medium or non-transient computer-readable medium or non-transitory computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java.®, Smalltalk or C++, and the like or in scripting language, such as Perl, Python, PHP, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance.

In the foregoing detailed description, numerous specific details are set forth to provide a thorough understanding of claimed subject matter. However, it will be understood by those skilled in the art that claimed subject matter may be practiced without these specific details. For example, the claimed subject matter may be practiced by using different gestures or icons than that described. In other instances, methods or apparatuses that would be known by one of ordinary skill have not been described in detail so as not to obscure claimed subject matter.

Some portions of the detailed description are presented in terms of algorithms or symbolic representations of operations on binary digital signals stored within a memory of a specific apparatus or specific electronic device or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Unless specifically stated otherwise, as apparent from the following discussion, it is appreciated that throughout this specification discussions utilizing terms such as “processing,” “displaying,” “receiving,” “providing” or the like refer to actions or processes of a specific apparatus, such as a special purpose computer or a similar special purpose electronic device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic device.

Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A method for recommending at least one feature of a product to a user, the method comprising:
tracking, by a computer processor, time spent on one or more features of the product during access of the product by the user;
identifying, by the computer processor, at least one feature on which time spent by the user is less than a predefined threshold;
detecting, by the computer processor, entry of an electronic device of the user in a proximity region of an electronic screen; and
recommending, by the computer processor, the at least one feature via the electronic screen.

2. The method as claimed in claim 1, wherein tracking comprises:
identifying presence of the electronic device of the user in proximity to the product; and
detecting the access of the product during presence of the electronic device of the user in proximity to the product.

3. The method as claimed in claim 2, wherein identifying comprises:
establishing identity of at least one of the electronic device and the user using at least one of cookie based identifier, Hypertext Transfer Protocol (HTTP) based identifier, Internet Protocol (IP) address, device identifier, user identifier, and user agent.

4. The method as claimed in claim 2, wherein tracking further comprises:
processing information present in signals emitted by a beacon associated with the product to determine details of the product and distance of the electronic device from the product.

5. The method as claimed in claim 2, wherein the at least one feature comprises a component of the product and detecting the access comprises:
detecting movement of the component of the product.

6. The method as claimed in claim 5, wherein tracking further comprises:
tracking time during which the component of the product is in movement while the electronic device is in proximity to the product.

7. The method as claimed in claim 5, wherein identifying comprises:
categorizing the component of the product as the at least one feature if no movement is detected or if the time during which the movement is detected is less than the predefined threshold.

8. The method as claimed in claim 2, wherein the at least one feature comprises an application present on the product and detecting the access comprises at least one of:
detecting access of the application present on the product, and
detecting movement of the product.

9. The method as claimed in claim 8, wherein tracking further comprises at least one of:
tracking time during which the application present on the product is accessed while the electronic device is in proximity to the product, and
tracking time during which the product is in movement.

10. The method as claimed in claim 9, wherein identifying comprises at least one of:
categorizing the application present on the product as the at least one feature if no access is detected but movement of the product is detected or if the time during which the access is detected is less than the predefined threshold.

11. The method as claimed in claim 2, wherein the product is an application present on a machine kept in a store and determining comprises:
identifying access of the electronic device of the user in proximity to the machine; and
detecting access of the application.

12. The method as claimed in claim 1 and further comprising:
storing one or more of the time spent on the one or more features of the product and the at least one feature.

13. The method as claimed in claim 1, wherein detecting the entry comprises:
processing information present in signals emitted by a beacon associated with the electronic screen to detect that the electronic device has entered into the proximity region of the electronic screen.

14. The method as claimed in claim 13, where in detecting the entry further comprises:
determining interaction of the user with the electronic screen; and
determining the product for which the user is interacting with the electronic screen.

15. The method as claimed in claim 1, where in the product comprises last accessed product by the user before entry of the electronic device of the user in the proximity region of the electronic screen.

16. A non-transient computer readable medium for storing computer instructions that when executed by at least one processor causes the at least one processor to perform a method for recommending at least one feature of a product to a user, the method comprising:
detecting entry of an electronic device of the user in a proximity region of an electronic screen;
retrieving data associated with the user from a storage device;
obtaining, using the data, time spent on one or more features of the product during access of the product by the user;
identifying, using the data, at least one feature on which time spent by the user is less than a predefined threshold; and
recommending the at least one feature via the electronic screen.

17. The computer readable medium as claimed in claim 16 and further comprising:
storing the at least one feature for different users;
generating a list of features that are recommended to more than threshold number of users for the product; and
recommending the list of features to a new user when electronic device of the new user is detected in the proximity region of the electronic screen and no access of the product by the new user is determined.

18. The computer readable medium as claimed in claim 16, wherein detecting comprises:
determining interaction of the user with the electronic screen; and
determining the product for which the user is interacting with the electronic screen.

19. The computer readable medium as claimed in claim 17, wherein retrieving comprises:
retrieving the data associated with the user for the determined product.

20. An apparatus for recommending at least one feature of a product to a user, the apparatus comprising:
a memory; and
one or more processors electronically coupled to the memory, the one or more processors, in conjunction with the memory, configured to perform
tracking time spent on one or more features of the product during access of the product by the user;
identifying at least one feature on which time spent by the user is less than a predefined threshold;
detecting entry of an electronic device of the user in a proximity region of an electronic screen; and
recommending the at least one feature to the user via the electronic screen.
